(19) United States
(12) Patent Application Publication
(10) Pub. No.: US 2026/0366704 A1
(43) Pub. Date: Nov. 19, 2026

(54) LUMINAIRE HAVING A FLEXIBLE HOUSING

(71) Applicant: SIGNIFY HOLDING B.V., EINDHOVEN (NL)

(72) Inventors: MICHAL JAN HORACZEK, BEST (NL); PETER JOHANNES MARTINUS BUKKEMS, DEURNE (NL); QUINTEN LENNART CONSTANT STEFAN VAN WAGENBERG, EINDHOVEN (NL); MARK ANDRE DE SAMBER, LOMMEL (BE); COEN THEODORUS HUBERTUS FRANSISCUS LIEDENBAUM, OSS (NL); JACOBUS PETRUS JOHANNES VAN OS, EINDHOVEN (NL)

(21) Appl. No.: 19/487,035

(22) PCT Filed: May 15, 2024
(86) PCT No.: PCT/EP2024/063315

§ 371 Date: Nov. 24, 2025

(30) Foreign Application Priority Data
May 25, 2023 (EP) 23175253.6

(51) Int. Cl. F21V 15/01; F21S 8/08; F21V 15/04; F21V 31/00; F21V 31/04; F21W 131/103

(52) U.S. Cl. CPC F21V 15/012; F21S 8/086; F21V 15/04; F21V 31/005; F21V 31/04; F21W 2131/103

(57) ABSTRACT

The invention provides a luminaire (10) comprising a housing (100) for mounting the luminaire (10) to a support (50), the housing (100) having a light exit window (150), and a lighting unit (180) arranged to emit light through the light exit window (150). The housing (100) has an inner housing part (110) and an outer housing part (120), the lighting unit (180) being provided in the inner housing part (110), and the outer housing part (120) enclosing the inner housing part (110), wherein the outer housing part (120) is made from a flexible material, and wherein a space (130) between the inner housing part (110) and the outer housing part (120) comprises a filler material (131).

### FIELD OF THE INVENTION

The invention relates to a luminaire having a flexible housing and to a method of manufacturing such luminaire.

### BACKGROUND OF THE INVENTION

Luminaires which are resistant to harsh environments, such as the outdoor environment, are known in the art. Those luminaires need to comply with numerous constraints, such as impact testing, ingress protection, and resistance to shock and vibration. Therefore, the housings of such luminaires are typically made of metal parts like powder coated high pressure die casted aluminum parts.

EP3186552B1 discloses a lighting fixture comprising a substantially flat sheet of metal supporting a circuit that comprises one or more light emitting diodes with one or more associated optics for manipulating emitted light. The circuit can be attached to, mounted next to, or integrated with the sheet of metal. In some examples, a layer of dielectric material adheres to the sheet of metal, and circuit elements adhere to the layer of dielectric material. The sheet of metal can provide a substrate for the circuit or a support for a freestanding circuit board that may be rigid or flexible.

EP3794276B1 discloses a LED lighting module having a metal housing panel and a transparent cover of a predominantly UV-impermeable material. The housing is hermetically sealed and an atmosphere containing argon is produced in the housing interior.

Luminaires having metal housings have numerous disadvantages, such as high weight, high number of parts, high material costs, as well as high energy consumption during the manufacturing process.

### SUMMARY OF THE INVENTION

It is an object of the present invention to at least partly overcome one or more of the aforementioned disadvantages of the prior art, or to provide a useful alternative.

In a first aspect, the invention provides a luminaire comprising a housing for mounting the luminaire to a support, the housing having a light exit window, and a lighting unit arranged to emit light through the light exit window. The housing has an inner housing part and an outer housing part, the lighting unit being provided in the inner housing part, and the outer housing part enclosing the inner housing part. The outer housing part is made from a flexible material, and a space between the inner housing part and the outer housing part comprises a filler material.

The luminaire of this invention has an outer housing part made of a flexible material instead of a conventional metal housing. This provides several advantages, such as a lower weight and a high impact resistance (IK protection). Furthermore, an outer housing part made of a single part enclosing the inner housing part is reducing the number of parts required, in particular the number of screws. At the same time the luminaire remains unaffected by harsh environment, such as the outdoor environment.

The luminaire has a housing configured to be mounted to a support. Especially, the support may be a pole structure such as for a streetlight pole, a sports area lighting pole, or an urban lighting pole. The support may also be a wall mounting support, or a support for suspending the luminaire, for example from a ceiling structure.

As indicated above, the luminaire comprises a lighting unit. The lighting unit may include one or more light sources. The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode, such as a passive-matrix (PMOLED) or an active-matrix (AMOLED). The light source may comprise a LED (light emitting diode). The term LED may also refer to a plurality of LEDs. Further, the term “light source” may also refer to a so-called chip-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. A COB is a multi LED chip configured together as a single lighting module. The term “light source” may also relate to a plurality of light sources, such as 2-2000 solid state light sources. Hence, the term “light source” especially refers to one or more solid state light sources, such as one or more LEDs.

Further, the lighting unit may include one or more elements allowing the lighting unit to be fixed to a support, such as herein especially the inner housing part. Such one or more elements may include one or more of a rail, or a host for a rail, a screw or bolt, a thread for a screw or a nut for a bolt, etc. etc. Alternatively or additionally, also a glue may be applied, such as a thermally conductive glue. Also with such glue, the lighting unit may be fixed to the internal housing part.

The luminaire has a housing comprising an inner housing part and an outer housing part. The inner housing part may be the core or the spine of the luminaire. The inner housing part may be rigid and may be made of metal or a polymeric material to give the luminaire mechanical stability. The inner housing part may further be made of a thermally conductive material so as to act as heat sink for the lighting unit.

The inner housing part may comprise a support part for supporting the lighting unit as described above. The lighting unit may be functionally (mechanically, electrically, and/or thermally) coupled to the support part of the inner housing part. The inner housing part may be hollow or partly hollow to reduce weight and so that it may be used to house or route electronics, electrical cables, and connectors.

The inner housing part may be monolithic, thus may be cast as a single piece or formed or composed of material without joints or seams. Alternatively, the inner housing part may comprise multiple parts. These multiple parts may include one or more parts for holding the lighting unit, one or more parts for holding electronics, one or more parts for mounting the luminaire to a support, and/or one or more parts for interfacing the inner housing part to the outer housing part.

The inner housing part has an inner housing part volume. The inner housing part volume may be significantly smaller than the total volume of the luminaire. The total volume of the luminaire may be at least 2 times larger, such as 3 times larger, preferably 5 times larger than the inner housing volume. In other words, the inner housing part may be regarded as a skeleton or a spine of the luminaire but does not define the outer shape or size of the luminaire. The outer shape or size of the luminaire is defined by the outer housing part.

The outer housing part at least partly encloses the inner housing part and is made from a flexible material. Thus, in other words the outer housing part may be non-rigid, deformable, soft, bendable, stretchable or elastic. To achieve this, the outer housing part may be fabricated from a material comprising rubbers, silicones, polymers, and/or thermoplastic elastomers.

The outer housing part protects the inner housing part and the internal components of the luminaire from the environmental conditions. Due to its properties, the outer housing part may be able to temporarily deflect under impact of (large) objects without causing fracture or tear of the flexible material, such as to achieve IK10 or IK08 test resistance. Furthermore, the internal components may be protected from water ingress without the need of additional seals or gaskets. In other words, the space between the outer housing part and the inner housing part is a sealed space, i.e. an enclosed area that is designed to be airtight and does not allow air, gas, or other substances to enter or escape.

The outer housing part may comprise one or more openings. One opening may correspond with the light exit window, ensuring that the light generated by the lighting unit can exit the housing through the light exit window. The outer housing part may have a second opening for interfacing with the inner housing part. In examples in which the outer housing part partially encloses the inner housing part, the outer housing part may be attached to the inner housing part. Such examples will be further described in more detail below.

The luminaire comprises a housing for mounting the luminaire to a support, the housing having a light exit window, and a lighting unit arranged to emit light through the light exit window. The housing has an inner housing part and an outer housing part, the lighting unit being provided in the inner housing part, and the outer housing part enclosing the inner housing part. The outer housing part is made from a flexible material. There may be a space between the inner housing part and the outer housing part which may comprise a filler material.

The flexible material may be stretchable, and the outer housing part may be in a stretched state.

A luminaire having an outer housing part made from a flexible and stretchable material provides a large amount of design freedom, since many different luminaire shapes may be achieved. The outer shape of the luminaire may be determined by the shape of the outer housing part once it is filled with the filler material. In other words, the stretched state may thus be imposed on the outer housing part by the filler material.

The outer housing part may be produced in a pre-formed state (deflated state) and may reach its final form once the luminaire is assembled and filled with the filler material (stretched state). In a basic comparison, the outer housing part may be compared to a shaped balloon or an inflatable object whose final form becomes visible only after inflating to transform it into a stretched state.

To this end, there may be a space in between the inner housing part and the outer housing part which may comprise the filler material. The filler material may provide sufficient mechanical stiffness so as to maintain the overall outer shape of the luminaire during use.

The filler material may comprise one or more of a material forming an expanding foam, a granular material, a fibrous material, a liquid, a gas, and a curable material. The filler material may thus be a material being in a solid or liquid state.

Many different materials may be chosen as filler materials, for example depending on the desired rigidity, weight, or application of the luminaire. Different filler materials may require different methods for filling the luminaire, which will be discussed in more detail below. The usage of sustainable materials as filler materials may be preferred to increase the overall recyclability of the luminaire.

In examples, the luminaire may comprise one or more mounting provisions for electrical components and/or modules.

The functionality of the luminaire may be further expanded by adding additional components or modules. To this end, the luminaire may comprise one or more mounting provisions.

Preferably, the one or more mounting provisions may be one or more cavities or compartments. The mounting provisions may be accessible in the form of a maintenance area. Such a maintenance area may for example be created at a location where the luminaire is accessible, such as at the back or at the bottom of the luminaire. The mounting provisions may be implemented as parts of the inner housing part. Easily accessible mounting provisions enable low-skilled maintenance and easy repair, change, or upgrade of parts of the luminaire. The mounting provisions may house for example LED boards, drivers, electrical connections, sensors, RF modules, or wireless communication modules.

The outer housing part of the luminaire may be made from the flexible material and the flexible material may be penetrated by radio frequency fields.

Compared to traditional (outdoor) luminaires made of metal, the luminaire of this invention may be made from a material which can be penetrated by radio frequency fields, or in other words is RF transparent. This makes it possible to integrate RF modules inside the luminaire for transmitting and receiving RF signals from the exterior environment of the luminaire.

In examples, the outer housing part of the luminaire may be made from the flexible material, and the flexible material may comprise rubber.

An outer housing part comprising rubber requires no post treatment, such as powder coating, grinding or stamping. In traditional aluminum luminaires, such a treatment step is required to make the luminaire resistant to harsh environments and to apply a desired color. Rubber is resistant to oxidation and may be molded in many different colors, making such treatments obsolete. A further advantage of an outer housing part comprising rubber may be that additional (rubber) seals and gaskets are not required for ingress protection, again reducing the number of parts of the luminaire.

An outer housing part comprising rubber may be fabricated using rubber molding and/or vulcanization. Types of rubber that may be suitable for the use in this invention may be natural rubbers (such as latex), synthetic rubbers (for example butadiene, styrene-butadiene, neoprene, polyisoprene, butyl, Thiokol's, EPDM, nitrile, thermoplastic elastomers, BUNA rubbers), or silicone rubbers. In addition, the rubber may also contain thermally conductive fillers to contribute to and improve the heat management of the luminaire.

The lighting unit may have a separate housing which may include the light exit window, such that the lighting unit is ingress protected.

The separate housing may provide ingress protection such as IP66 or higher. A lighting unit having a closed or sealed housing eliminates the need for an additional sealing at the interface of the outer housing part and the light exit window. The internal components of the lighting unit are already protected against the outdoor environment.

Alternatively or additionally, the outer housing part may provide a hermetic seal for the luminaire such that the luminaire has ingress protection.

The outer housing part may serve as an ingress protection (IP) seal for the interfaces of the outer housing part with other parts of the luminaire, such as the light exit window, the inner housing part, and potentially other parts of the luminaire that protrude from an opening in the outer housing part. The flexible outer housing part can interface the materials as a hermetic seal, thereby eliminating the need for additional seals or gaskets. The outer housing part may be fabricated such that it comprises one or more openings that are a tight or stretch fit with the other parts of the luminaire it encloses, thus creating a sealed interface which is water-and dust-tight.

Ingress protection refers to the ability of the luminaire to hold up against moisture or dirt. Ingress protected luminaires receive a so-called IP rating, which has two digits. The first digit rates the protection level against solid objects, like dirt, dust, and other particulates. This is a concern because some of these particles may come into contact with electrical conductors and may cause damage. The second digit in the IP rating determines how well the luminaire is protected against moisture. Components inside he luminaire should stay dry after exposure to moisture like drips, sprays, and submersions. Outdoor fixtures should stand up to rain and downpours and should also stand up to any moisture from cleaning. The luminaire of this invention may have at least an IP rating of IP44, such as IP65, preferably at least IP66.

Alternatively or additionally, the materials may be interfaced using an additional means. The interface may comprise one or more of a mechanical interface, a clamp, a sealant material, polymer welding, and a Ziploc sealing.

An interface between the outer housing part and the inner housing part may be created using many different means. A mechanical interface may for example comprise mechanical structures (e.g. an interference geometry) that may be located on the surface of the inner housing part and/or the outer housing part. When mounted these structures may interlock due to the mechanical structure in combination with a strained or stretched outer housing part. In this way an IP tight connection may be created. The IP connection may also be created using additional parts such as a clamp or other sealant materials, such as glue. The interface may also be created using polymer welding. An alternative mechanical interface may be the use of a Ziploc or Ziploc-like sealing. In such an interface the outer housing part and the inner housing part may be connected using an interlocking mechanism involving plastic edges on both sides that click together. A seal or interface created using a Ziploc sealing is tight enough to keep air and moisture out and strong enough to keep the filler material inside the luminaire.

It should be noted that these are examples of different ways to create an interface between the outer housing part and the inner housing part, and that the skilled person is able to design alternatives without departing from the scope of the appended claims.

In examples, the outer housing part and the inner housing part may be connected at an interface, and the inner housing part may protrude from the outer housing part at the interface.

The inner housing part may protrude from the outer housing part at the interface. Thus, enabling that the inner housing part may be used for mounting the luminaire to a support.

The inner housing part may be made from a rigid material such as metal or a polymer. The inner housing part may therefore be most suitable for mounting the luminaire to a support and for carrying the weight of the luminaire. The inner housing part may for example be shaped like a bar or like a rod, holding the light engine at a first part, and serving as (part of) the spigot of the luminaire at a second part. In examples, the luminaire may be an outdoor luminaire, such as a streetlight.

The outer housing part and/or the filler material may additionally or alternatively provide impact protection for the luminaire.

The flexible outer housing part (optionally in combination with the filler material) can temporarily deflect under impact of objects without causing fracture or tear of the material. Thus, is resulting in an luminaire which is impact resistant, such as impact resistant according to an IK10 or IK08 rating. An impact resistance IK rating is a two-digit number used to provide an indication resistance to damage from an impact. The rating scale indicates the amount of protection provided by an electrical enclosure (including luminaires) against an impact.

During an impact, the location of the impact may be protected by the outer housing part and the filler material. Hence, absorbing the impact without damaging the luminaire, such as protecting the internal components of the luminaire. The thickness of the filler material at the potential impact location may be more than four times, such as six times, preferably more than ten times the thickness of the outer housing part.

In a second aspect, the invention provides a method of manufacturing an luminaire comprising a housing having an inner housing part, an outer housing part, a lighting unit, and a light exit window. The method comprises the steps of:
providing the inner housing part holding the lighting unit;
providing the outer housing part, wherein the outer housing part is made from a flexible material;
inserting the inner housing part holding the lighting unit into the outer housing part such that the lighting unit is positioned to emit light through the light exit window;
inserting a filler material into a space between the inner housing part and the outer housing part.

The method of manufacturing the luminaire of this invention has several advantages when compared to manufacturing a luminaire having an aluminum housing. The manufacturing process is reduced in cost and improved in sustainability. The method of this invention eliminates the high energy consumption associated with manufacturing aluminum and the expensive tooling needed for the process. Furthermore, as mentioned above, the luminaire has a reduced number of parts, making the assembly easier and more efficient.

The flexible material may be stretchable, and the method may comprise the steps of:
providing the inner housing part holding the lighting unit;
providing the outer housing part, wherein the outer housing part is made from the flexible material being stretchable;
stretching the outer housing part such that the inner housing part can be accommodated;
inserting the inner housing part holding the lighting unit into the outer housing part such that the lighting unit is positioned to emit light through the light exit window;
inserting a filler material into a space between the inner housing part and the outer housing part such that the outer housing part is in a stretched state.

In examples, the outer housing part and the inner housing part may be connected at an interface, wherein the inner housing part may protrude from the outer housing part at the interface, and wherein the method, after inserting the inner housing part into the outer housing part, may additionally comprise the step of:
securing the outer housing part to the inner housing part at the interface using one or more of a mechanical interface, a clamp, a sealant material, polymer welding, and a Ziploc sealing.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts an exploded view of the luminaire;

FIG. 2 is a cross-section of the luminaire;

FIG. 3 shows an example of a part used in the luminaire;

FIG. 4 shows a cross-section of the luminaire including mounting provisions; FIG. 5a-b show an example of an ingress protected lighting unit;

FIG. 6 shows an example application of the luminaire; and

FIG. 7 shows a flow chart of the method to manufacture the luminaire.

The schematic drawings are not necessarily to scale.

### DETAILED DESCRIPTION OF THE EMBODIMENTS

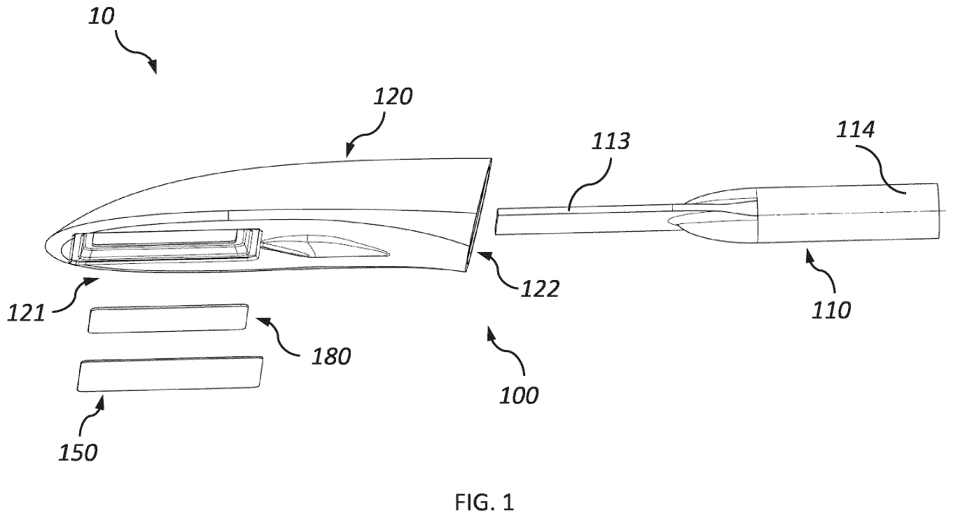

FIG. 1 schematically depicts an exploded view of an example of a luminaire according to the invention. The luminaire 10 comprises a housing 100, the housing 100 having a light exit window 150, and a lighting unit 180 arranged to emit light through the light exit window 150. The housing 100 has an inner housing part 110 and an outer housing part 120, the lighting unit 180 being provided in the inner housing part 110.

The inner housing part 110 may be described as the core, the spine, or the skeleton of the luminaire 10. The inner housing part 110 may be rigid and may be made of metal or a polymeric material to give the luminaire 10 mechanical stability. The inner housing part 110 may further be made of a thermally conductive material so as to act as heat sink for the lighting unit 180.

The inner housing part 110 may comprise a support part 113 for supporting the lighting unit 180. The lighting unit 180 may be functionally (mechanically, electrically, and/or thermally) coupled to the support part 113 of the inner housing part 110. There may be a thermal interface material between the lighting unit 180 and the inner housing part 110 to improve thermal contact between those parts. The inner housing part 110 may be hollow or partly hollow to reduce weight and so that it may be used to house or route electronics, electrical cables, and connectors. The inner housing part 110 may have a second part 114 adapted to be connected to a support 50 for mounting the luminaire 10.

In the example luminaire shown in FIG. 1, the outer housing part 120 comprises a first opening 121 and a second opening 122, wherein the first opening 121 encloses the circumference of the light exit window 150, wherein the lighting unit 180 is arranged to emit light through the light exit window 150. The second opening 122 is interfaced with the inner housing par 110 such that the outer housing part 120 encloses at least part of the inner housing part 110.

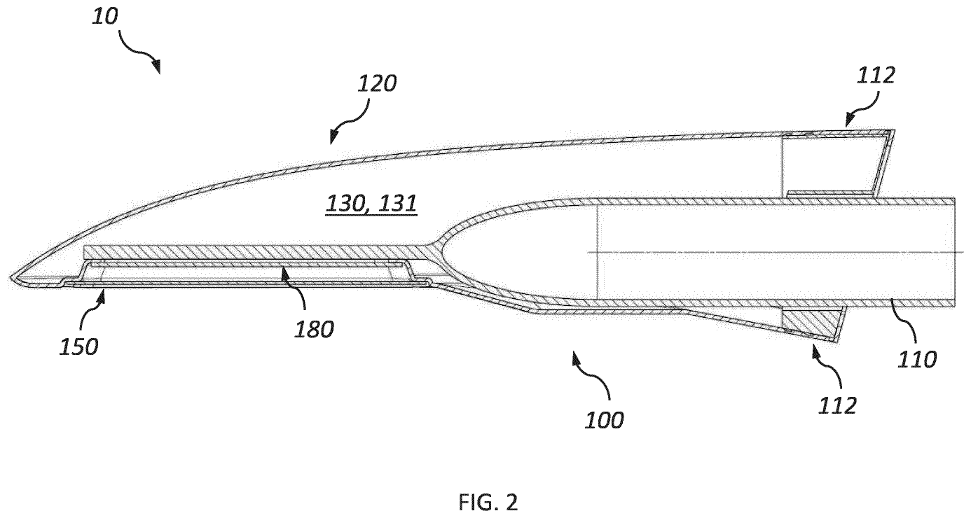

FIG. 2 shows a cross-section through the center of the example luminaire 10 as shown in FIG. 1. Here the luminaire is shown after assembly. In an assembled state, the outer housing part 120 encloses the inner housing part 110. The lighting unit 180 is attached to the inner housing part 110 and aligned with the light exit window 150, such that the lighting unit 180 emits light through the light exit window 150 to the environment of the luminaire 10. The first opening 121 of the outer housing part 120 encloses the edges of the light exit window 150.

The luminaire 10 shown depicts an example implementation in which the outer housing part 120 only partly encloses the inner housing part 110. The inner housing part 110 may thus be partly visible on the outside of the luminaire 10 and may therefore also be used for mounting the luminaire 10 to a support 50. At the location where the inner housing part sticks out from the outer housing part 120, the two housing parts may have an interface 112 where both housing parts can be connected.

To assemble the luminaire 10, the inner housing part 110 holding the lighting unit 180 is provided. The outer housing part 120 is provided, wherein the outer housing part 120 is made from a flexible material. The material may additionally be stretchable and may need to be stretched during manufacturing of the luminaire 10, to be able to accommodate the inner housing part 110 when the inner housing part 110 holding the lighting unit 180 is inserted into the outer housing part 120. In examples in which the outer housing part 120 and the inner housing part 110 have an interface 112, the outer housing part 120 may need to be secured to the inner housing part 110 at the interface 112.

The second opening 122 of the outer housing part 120 may be secured to the inner housing part 110 by a mechanical interface which makes use of the dimensions, flexibility, and elasticity of the outer housing part 120. The outer housing part 120 may be intentionally strained by the geometry of the interface 112 with the inner housing part 110 so that the interconnection of those parts may be IP tight. The mechanical interface 112 may also have an interference geometry which may contribute to a stretch fit of the outer housing part. Alternatively or additionally, the outer housing part 120 may be secured to the inner housing part 110 also a clamp method, sealant materials such as a glue, local heating method to remelt the rubber at the locations of the interface 112 (polymer welding), or a Ziploc principle may be used.

Once the outer housing part 120, the inner housing part 110 holding the lighting unit 180, and the light exit window 150 are aligned and secured, a filler material 131 is inserted into the outer housing part 120 to secure the mechanical structure and to maintain desired shape of the luminaire 10. The filler material 131 is inserted into a space 130 between the inner housing part 110 and the outer housing part 120. The outer housing part 120 may thus be in a stretched state after inserting the filler material 131. The outer shape of the luminaire 10 may thus be determined by the shape of the outer housing part 120 once it is filled with the filler material 131.

This may offer great design freedom since many different shapes can be achieved for many different applications. Parameters that can be varied in the design are for example the outer shape of the outer housing part 120, the thickness of the outer housing part 120 (and therewith also its flexibility), the shape and size of the inner housing part 110, the size and shape of the space 130, the thickness of the filler material 131, and the type and amount of filler material 131.

It should be noted that the example luminaire 10 described above is merely one example according to the invention. There are many different alternative implementations such as a suspended luminaire. In such an alternative example, the inner housing part 110 may be oriented vertically or may have a shape completely different from a bar or a rod shape. The inner housing part may be completely enclosed by the outer housing part 120. The outer housing part 120 may be used to mount the luminaire 10 to a support 50, which may in this case be a hook, a chain, a ring, or any other means to suspend the luminaire 10.

Examples of filler materials may include but are not limited to wool, fabric scraps, jeans scraps, wooden powder, wooden flakes, wooden fibers, polyurethane foam, polystyrene foam, polystyrene balls, gas-filled pellets, epoxy resins, foam concrete, gypsum foam, shredded materials such as plastic, gases such as air or nitrogen, fluids such as oils (synthetic, mineral, bio-based, and/or used oil), or engineered electrically non-conductive fluids used for instance for immersion cooling. The filler material may also be a combination of the above materials. The filler material may also contain voids to minimize weight. The filler material may also be attached to the outer housing part or to the inner housing part, enabling to remove the full outer housing part for service purpose and easy recycling.

As stated above, different filler materials 131 may require different methods or processes for filling the luminaire. The filler material 131 may be inserted for instance by a blowing process. The filler material 131 may be forming after insertion. In such cases the filler material 131 may create a foam which expands after insertion in the space between the outer housing part 120 and the inner housing part 110. Such foam may for example be a 2-component material, or a material which reacts and expands using a catalyst. The space may alternatively or additionally be filled with pre-fabricated filling components, such as for example gas-filled pallets or polystyrene balls, resulting in a low density, low weight fill. The space 130 between the outer housing part 120 and the inner housing part 110 may also be filled with a fluid in the shape of a gas or a liquid. The fluid fill may be followed by a curing step resulting in a solid or semi-solid texture. Filling the enclosure with a gas (e.g. nitrogen) may create a ‘balloon-like’ structure that is rigid enough and will add little additional weight to the luminaire 10. Liquid filling such as oils (e.g. synthetic, mineral, bio based, used oil) or engineered fluids used for instance for immersion cooling may be suitable filler liquids. In view of sustainability, there may be different options for using bio-based, easily recyclable, or already recycled materials.

It should be noted that these are mere examples of different filler materials 131 and methods to apply those materials in the luminaire 10, and that the skilled person is able to design alternatives without departing from the scope of the appended claims.

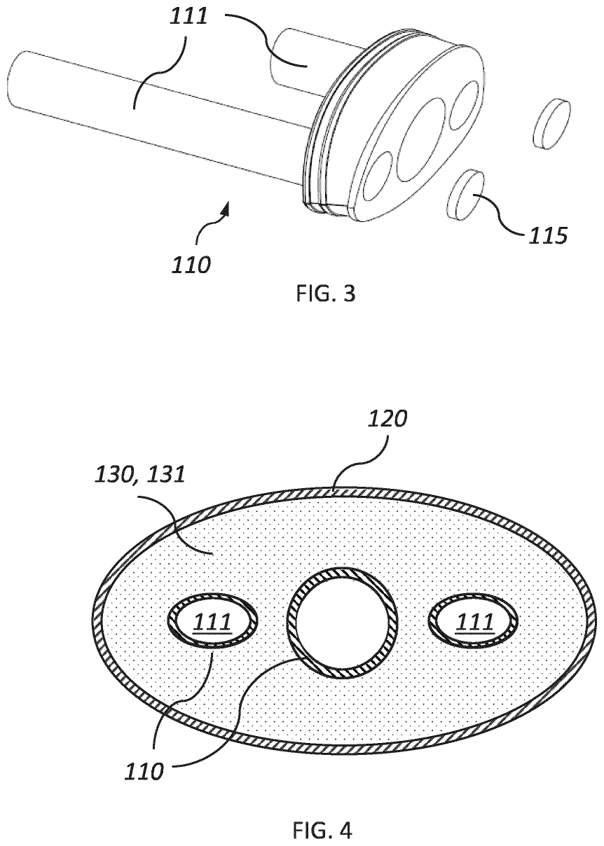

FIG. 3 shows an example of an optional, additional housing part of the inner housing part 110 that may be used in the luminaire 10. As already discussed above, the inner housing part 110 may be monolithic but may also comprise multiple parts. These multiple parts may include one or more parts for holding the lighting unit, one or more parts for holding electronics, one or more parts for mounting the luminaire to a support, and/or one or more parts for interfacing the inner housing part to the outer housing part.

The additional inner housing part depicted in FIG. 3 may also be called an end cap and may serve multiple purposes. It may serve to create one or more mounting provisions 111 for electrical components and/or modules. Alternatively or additionally, it may comprise a mechanical interface 112 for easily securing the outer housing part 120 to the inner housing part 110 at the end cap.

The additional inner housing part 110 may have mounting provisions 111, for example implemented as isolated compartments or cavities for housing e.g. a LED board, a driver, RF module, battery, sensors, a wireless communication module, or other components or cabling of the luminaire 10. The mounting provisions 111 may be easily accessible from the exterior of the luminaire 10 and may form a maintenance area where the mounting provisions 111 may be accessible via openings which may be sealed with a watertight plug 115 or lid during operation of the luminaire. Easily accessible mounting provisions enable low-skilled maintenance and easy repair, change, or upgrade of parts of the luminaire.

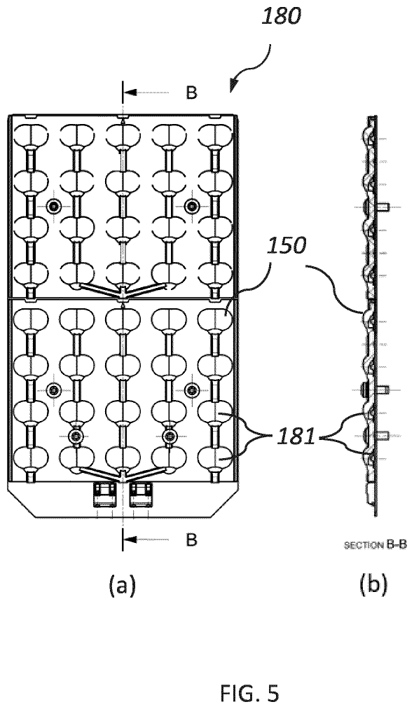

FIG. 4 shows another cross section of the luminaire 10 having mounting provisions 111. The inner housing part 110 may be at the core of the luminaire 10, surrounded by the space 130 filled with the filler material 131, and delimited on the outside by the outer housing part 120. The mounting provisions 111 may be created by the inner housing part and may be located within the space 130, such that the mounting provisions are (at least partly) surrounded by the filler material 131 and the outer housing part 120. Thus, ensuring that the mounting provisions 111, or rather the components of the luminaire 10 mounted inside the mounting provisions 111 are protected by the filler material 131 and the outer housing part 120 from for example impacts and/or ingress. The luminaire 10 may comprise a single mounting provision 111, but may also comprise more than one, like more than 2, such as more than 3 separate mounting provisions 111. The location, shape and size of the mounting provisions 111 may vary, for example depending on the size of the components or of the luminaire, the routing of cables, the protection required by the component, and the overall shape of the luminaire. Different shapes and implementations of the luminaire 10 may have different requirements for the location and accessibility of the mounting provisions 111.

In an example, the luminaire 10 may comprise a lighting unit 180 which may have a separate housing, already including the light exit window 150. Thus, providing a lighting unit 180 which may be already ingress protected. Such lighting units 11 are known in the art and readily available. An example of such a lighting unit 180 is shown in FIGS. 5a and 5b.

FIGS. 5a-b show an example lighting unit 180 which is an integral unit, ready for use, such as for outdoor use. Hence, the lighting unit 180 may include a separate housing, such as an IP66 (or higher) housing, and may include one or more (solid state) light sources 181. As it is common for such integral lighting units, the lighting unit 180 comprises a light exit window 150. A separate light exit window 150 may thus be optional. The light exit window 150 of the lighting unit 180 may typically be a lens plate, already comprising optics for distributing the light of each of the one or more light sources 181. In such examples in which the lighting unit 180 already comprises a separate housing, the luminaire 10 may have an opening in the housing 100 that allows for the light emitted by the lighting unit 180 to exit the housing 100.

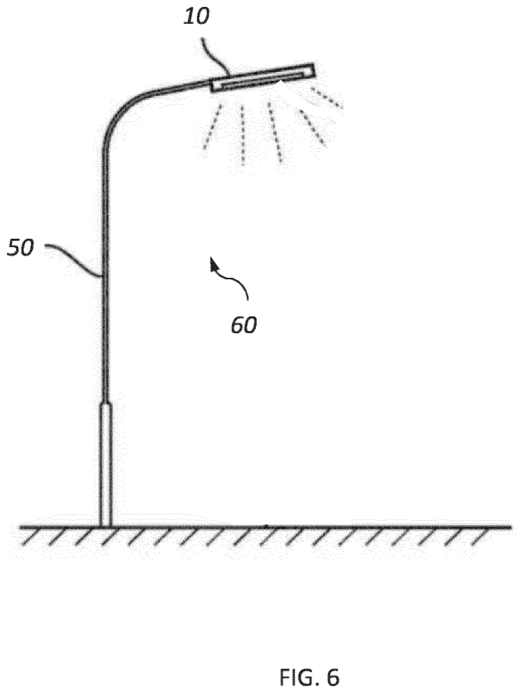

FIG. 6 shows one of the possible application of the luminaire 10 of this invention. The luminaire 10 may be used as an outdoor luminaire, such as a streetlight 60. The luminaire 10 has a housing 100 for mounting the luminaire 10 to a support 50. In this example, the support may be a streetlight pole 50. Utilizing the luminaire 10 of this invention as a streetlight 60 may have several advantages. Since the luminaire 10 is reduced in weight significantly, the luminaire 10 may first of all be easier to mount on the streetlight pole 50. It may also influence the dynamic behavior the streetlight pole 50, since the luminaire 10 may not be in the critical location related to eigen-frequencies. The flexible outer housing part 120 may also act as a damper system for high winds and prevent vibrations. It may thus be possible to use thinner and more elegant poles for mounting the luminaire 10.

There are however many other advantageous uses of the luminaire of this invention, may it be in the outdoor environment or in the indoor environment. The luminaire 10 may be used in environments where ingress protection, impact protection, or harsh environments play a role. Examples of possible applications may include but are not limited to urban area lights, parking lot lighting, sports arena lighting, (auxiliary) automotive lighting, factory lighting, swimming pool lighting, vandalism-proof lighting, etc.

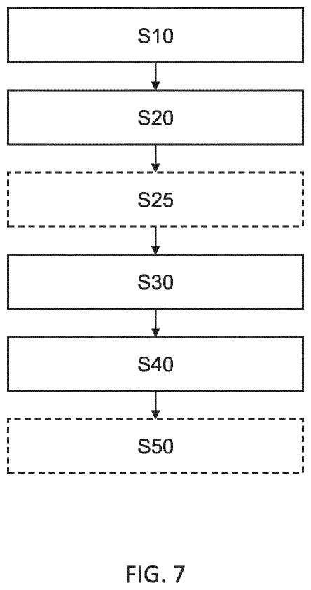

FIG. 7 shows a basic flow chart illustrating different steps of the method of manufacturing the luminaire 10. The method comprises four main steps S10, S20, S30 and S40. The remaining steps may be optional or may be depending on the specific implementation of the method.

In S10 the inner housing part 110 holding the lighting unit 180 is provided. In S20 the outer housing part 120 which is made from a flexible material is provided. Subsequently, in step S30 the inner housing part 110 holding the lighting unit 180 is inserted into the outer housing part 120, such that the lighting unit 180 is positioned to emit light through the light exit window 150. In step S40 a filler material 131 is inserted into a space 130 between the inner housing part 110 and the outer housing part 120.

In examples, the outer housing part 120 may be made from a flexible and stretchable material. In such examples the method may additionally comprise step S25, in which the outer housing part 120 may be stretched such that the inner housing part 110 can be accommodated. After inserting the filler material 131, the outer housing part 120 may be in a stretched state.

Additionally or alternatively, the outer housing part 120 and the inner housing part 110 may be connected at an interface 112, wherein the inner housing part 110 may protrude from the outer housing part 120 at the interface 112. The method may for such implementations comprise and additional step S50 comprising securing the outer housing part 120 to the inner housing part 110 at the interface 112 using one or more of a mechanical interface, a clamp, a sealant material, polymer welding, and a Ziploc sealing.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The various aspects discussed in this patent can be combined in order to provide additional advantages. Further, the person skilled in the art will understand that embodiments can be combined, and that also more than two embodiments can be combined.

1. A luminaire comprising:
a housing for mounting the luminaire to a support, the housing having a light exit window, and
a lighting unit arranged to emit light through the light exit window,
wherein the housing has an inner housing part and an outer housing part, the lighting unit being provided in the inner housing part, and the outer housing part enclosing the inner housing part,
wherein the outer housing part is made from a flexible material,
wherein a space between the inner housing part and the outer housing part comprises a filler material, and
wherein the filler material comprises one or more of a material forming an expanding foam, a granular material, a fibrous material, a liquid, and a curable material,
wherein the flexible material is stretchable, and wherein the outer housing part is in a stretched state, and
wherein the luminaire has an outer shape determined by the outer housing part and the filler material, and wherein the stretched state is imposed on the outer housing part by the filler material.

2. (canceled)

3. (canceled)

4. The luminaire according to claim 1, wherein the luminaire comprises one or more mounting provisions for electrical components and/or modules.

5. The luminaire according to claim 1, wherein the outer housing part is made from the flexible material, and wherein the flexible material can be penetrated by radio frequency fields.

6. The luminaire according to claim 1, wherein the outer housing part is made from the flexible material, and wherein the flexible material comprises rubber.

7. The luminaire according to claim 1, wherein the lighting unit has a separate housing including the light exit window, such that the lighting unit is ingress protected.

8. The luminaire according to claim 1, wherein the outer housing part provides a hermetic seal for the luminaire such that the luminaire is ingress protected.

9. The luminaire according to claim 1, wherein the outer housing part and the inner housing part are connected at an interface, and wherein the inner housing part protrudes from the outer housing part at the interface.

10. The luminaire according to claim 9, wherein the interface comprises one or more of a mechanical interface, a clamp, a sealant material, polymer welding, and a Ziploc sealing.

11. The luminaire according to claim 1, wherein the outer housing part and/or the filler material provide impact protection for the luminaire.

12. The luminaire according to claim 1, wherein the luminaire is a streetlight.

13. A method of manufacturing a luminaire comprising a housing having an inner housing part, an outer housing part, a lighting unit, and a light exit window, wherein the method comprises the steps of:
providing the inner housing part holding the lighting unit;
providing the outer housing part, wherein the outer housing part is made from a flexible material being stretchable;
inserting the inner housing part holding the lighting unit into the outer housing part such that the lighting unit is positioned to emit light through the light exit window;
inserting a filler material into a space between the inner housing part and the outer housing part such that the outer housing part is in a stretched state, wherein the filler material comprises one or more of a material forming an expanding foam, a granular material, a fibrous material, a liquid, and a curable material.

14. The method according to claim 13, wherein the method additionally comprises the steps of:
stretching the outer housing part such that the inner housing part can be accommodated.

15. The method according to claim 13, wherein the outer housing part and the inner housing part are connected at an interface, wherein the inner housing part protrudes from the outer housing part at the interface, and wherein the method, after inserting the inner housing part into the outer housing part, additionally comprises the step of:
securing the outer housing part to the inner housing part at the interface using one or more of a mechanical interface, a clamp, a sealant material, polymer welding, and a Ziploc sealing.
